(19) United States
(12) Patent Application Publication
(10) Pub. No.: US 2006/0060224 A1
(43) Pub. Date: Mar. 23, 2006

(54) Dishwasher

(75) Inventors: Sang Heon Yoon, Seoul (KR); Nung Seo Park, Bupyeong-gu (KR); Dae Yeong Han, Seoul (KR); Hung Myong Cho, Gimhae-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/065,304

(22) Filed: Feb. 25, 2005

(30) Foreign Application Priority Data
Sep. 17, 2004 (KR) P2004-74632

(51) Int. Cl. B08B 3/00

(52) U.S. Cl. 134/56 D; 134/104.2

(57) ABSTRACT

The present invention provides a dishwasher, in which a disposer having a predetermined shape and a screen are provided to prevent large-sized particles involved in water from entering a lower housing and by which a pressure working on a filter can be lowered. The present invention includes a sump receiving water for washing dishes, a main motor circulating the water received in the sump, an impeller coupled with the main motor to pump the water, and a screen provided between the sump and a lower housing provided over the sump to filter off soil included in the water introduced into the lower housing.

This application claims the benefit of the Korean Application No. P2004-074632 filed on Sep. 17, 2004, which is hereby incorporated by reference.

### BACKGROUND OF THE INVENTION

1. Field of the Invention

The present invention relates to a dishwasher, by which water can be effectively filtered.

2. Discussion of the Related Art

Generally, a dishwasher is an automatic machine for washing dishes. The dishwasher is operative in washing, rinsing, drying, and keeping dishes therein to relive a home labor burden.

Dishwashers are categorized into a shower type and an ultrasonic type. And, the shower type dishwasher is preferred as a home appliance. The shower type dishwasher washes dishes in a manner of spraying hot water including a detergent therein on the dishes put on a dish rack.

The water is sprayed using a propeller or a rotating pipe having a multitude of perforated holes.

A dishwasher according to a related art is briefly explained with reference to FIG. 1 as follows.

Referring to FIG. 1, a dishwasher according to a related art consists of a water collection part 1 collecting water therein, a motor 2 for driving the water collection part 1, and upper and lower washing parts 3 and 4 spraying the water flowing from the water collection part 1.

A main water collection part 1a is provided to the water collection part 1 supplied with the water for dishwashing and collecting to discharge the used water after dishwashing.

On the main water collection part 1a provided is a channel forming part 1b having a channel for moving the water circulating within the dishwasher to the upper and lower washing parts 3 and 4. And, a filtering part 1c is connected to the channel forming part 1b to remove garbage by filtering the water.

The motor 2 provides power for driving a washing pump to supply the water to the upper and lower washing parts 3 and 4 in performing dishwashing or a drain pump to drain the water after completion of washing.

The upper and lower washing parts 3 and 4, in which the dishes are substantially washed, communicate with the water collection part 1 via a connecting pipe. A spray arm (not shown in the drawing) provided each of the upper and lower washing parts 3 and 4 sprays the water supplied from the water collection part 1 to wash the used dishes.

An operation of the related art dishwasher is sequentially explained as follows.

First of all, the dishes to be washed are put on the dish rack and a specific cycle is then inputted to the dishwasher. If so, the main water collection part of the dishwasher is filled up with water via a water supply valve connected to an external device.

Subsequently, the dishwasher drives its heater to heat the supplied water and the motor to actuate the washing pump. In doing so, the heated water is moved by the washing pump to the upper and lower spray arms via the connecting pipe. The water arriving at each of the spray arms is sprayed via a spray nozzle to remove garbage or soil attached to surfaces of the dishes.

The water and soil detached from the dishes after washing are collected by the main water collection part. If a pollution degree of the water exceeds a predetermined level, the dishwasher discharges the water containing the soil or garbage therein via the drain pump and is supplied with clean water.

If the pollution degree of the water is below the predetermined level, the dishwasher purifies the water collected in the water collection part and then moves the purified water to the upper and lower spray arms again. After completion of washing, the water gathering in the water collection part is externally discharged via the drain pump together with the garbage or soil.

Meanwhile, the related art dishwasher uses a 3-way valve, and more particularly, a solenoid valve to control a flowing direction of the water. The solenoid valve, which is a valve automatically turned on/off using the principle of electromagnetic induction, is mainly used for an automation or safety device of a complicated machine.

However, the related art dishwasher has the following problems or disadvantages.

First of all, when the pumped water is introduced into the channel forming part together with the soil including garbage, the soil having a relatively large size may block the filter.

Secondly, in case that the garbage or filter blocks the filter, the pressure is excessively applied to the filter to transform or distort.

### SUMMARY OF THE INVENTION

Accordingly, the present invention is directed to a dishwasher that substantially obviates one or more problems due to limitations and disadvantages of the related art.

An object of the present invention is to provide a dishwasher, by which water can be efficiently filtered.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher according to the present invention includes a sump receiving water for washing dishes, a main motor circulating the water received in the sump, an impeller coupled with the main motor to pump the water, and a screen provided between the sump and a lower housing provided over the sump to filter off soil included in the water introduced into the lower housing.

Preferably, the screen includes a passing hole to be penetrated by a shaft of the main motor and a multitude of perforated holes through which the water passes.

More preferably, the passing hole is formed at a center of the screen.

Preferably, a hook is provided inside the sump to lock the screen.

Preferably, the dishwasher further includes a disposer finely grinding the soil included in the water introduced into the lower housing.

More preferably, the disposer is shaft-coupled with the main motor to be rotated.

More preferably, the disposer has a polygonal shape.

More preferably, a width of the disposer is greater than a diameter of the passing hole of the screen.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a dishwasher according to a related art;

FIG. 2 is a block diagram of a dishwasher according to one embodiment of the present invention;

FIG. 3 is an exploded diagram of major elements of the dishwasher in FIG. 2;

FIG. 4 is an exploded diagram of a screen provided within a sump according to the present invention;

FIG. 5 is a layout of a screen and a disposer according to one embodiment of the present invention; and

FIG. 6 is a layout of a screen and a disposer according to another embodiment of the present invention.

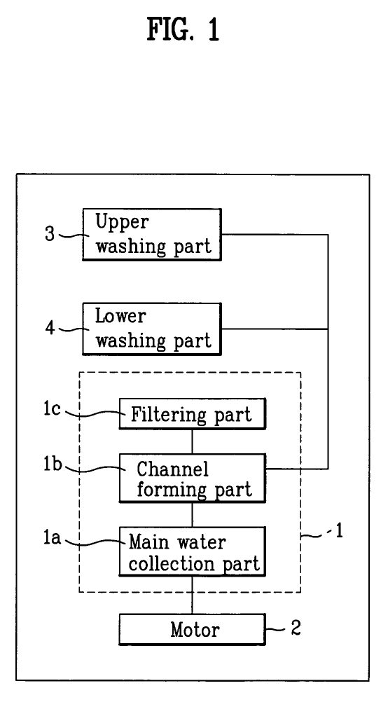

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, a channel allowing water to flow herein in a dishwasher according to the present invention is explained as follows.

A sump 100 receiving water is provided to a lower end of the dishwasher. And, a lower housing 200 provided with a soil chamber 210 is situated on the sump 100.

An upper housing 300 having a channel for water is situated on the lower housing 200, and a cover 400 covering the upper housing 300 is provided to the topside of the upper housing 300.

The above-configured dishwasher is supplied with water from a water supply source. The water in the sump 100 is moved to the upper housing 300 via the lower housing 200 by a washing pump. The water is then moved to an upper washing part (arm) 30 by a channel control device 500 via an upper main channel 330 formed in the upper housing 300 and is moved to a lower washing part (arm) 40 via a lower main channel 320 as well.

And, a portion of the water is moved to a drain pump 110 via a sampling channel 310. The water 110 having passed through the drain pump 110 is introduced into the soil chamber 210 of the lower housing 200 to be filtered by a filtering part 410 provided to the cover 400. The water having filtered by the filtering part 410 is then gathered in the sump 100 again.

Compared to the related art dishwasher, the dishwasher according to the present invention includes the sampling channel 310 for pollution degree measurement and filtering. As the sampling channel 310 is connected to the soil chamber 210 via the drain pump 110 from the washing pump, a pressure working on the filtering part 410 by the washing pump is lowered. Hence, the filtering part 410 situated at the cover 400 is barely blocked by the soil.

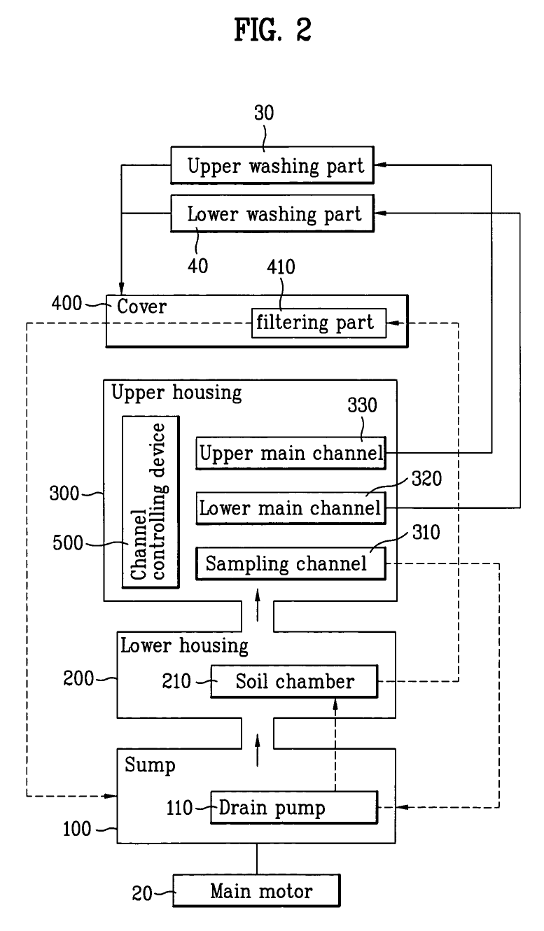

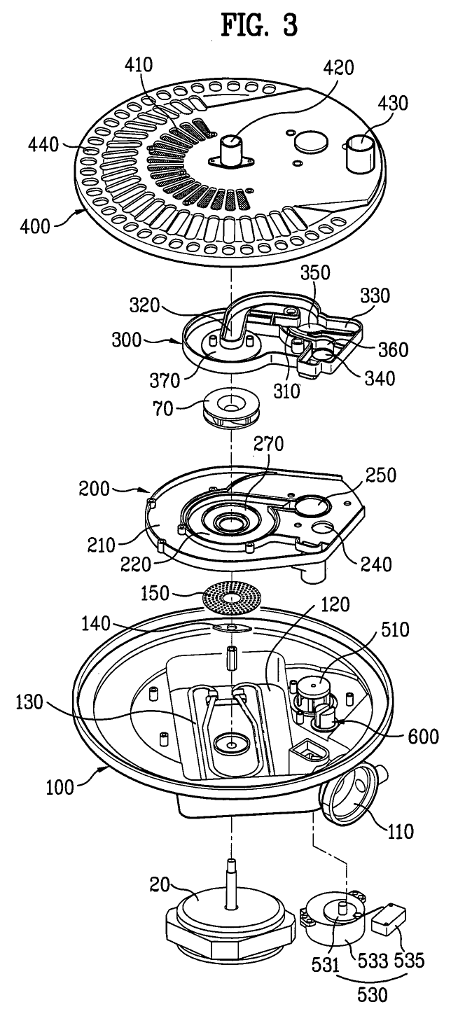

A water collection device of the dishwasher in FIG. 2 is explained in detail with reference to FIG. 3 as follows.

Referring to FIG. 3, a main motor 20 is provided to a lower end of the water collection device to provide a dynamic power to the dishwasher. And, a sump 100 having a water receiving portion 120 for collecting water therein is situated on the main motor 20.

A lower housing 200 having the soil chamber 210 is situated on the sump 100. And, an upper housing 300, in which the channel for a water flow is formed, is provided on the lower housing 200. Moreover, a cover 400 is situated on the upper housing 300 to filter and recover the water to the sump 100.

A heater 130 is situated within the sump 100. The heater 130 is preferably submerged in the water while the dishwasher is operating. And, the heater 130 is operative in heating the water at a proper temperature to facilitate the dishwashing.

A main motor 20 and a valve control device 530 for controlling a channel control valve are situated at an external bottom surface of the sump 100. And, a drain pump 210 110 is situated at an external lateral side of the sump 100. Alternatively, the main motor 20 and the valve control device 530 can be provided to the external lateral side of the sump 110 and the drain pump 110 can be provided to the external bottom surface of the sump 110.

A disposer 140 for finely grinding the soil involved in the water is situated in the sump 110. The disposer 140 is assembled to the main motor 20 to be rotated. A screen 150 for primarily filtering off the soil involved in the water introduced into the lower housing 200 is situated onto the disposer 140.

A first perforated hole 240 is formed at the lower housing 200 to be penetrated by a pollution degree sensor 600 for measuring a pollution degree of water. And, a soil chamber 210 is provided to the lower housing 200 to collect the water having passed through the pollution degree sensor 600 and the drain pump 110.

An impeller receiving portion 270 is provided to a center of the lower housing 200 to receive an impeller 70 therein. And, an introducing channel 220 for introducing the water moved by the impeller 70 into the channel control valve 510 is provided outside the impeller receiving portion 270 in the lower housing 200. Moreover, a second perforated hole 250 is formed at a portion of the lower housing 200 connected to the introducing channel 220 to be penetrated by the channel control valve 510.

An impeller cap 370 is provided to the upper housing 300 to receive an upper part of the impeller 70. And, the second perforated hole 350 is provided to the upper housing 300 to be penetrated by the channel control valve 510. An upper main channel 330, connected to the second perforated hole 350 to send the water to an upper washing arm, a lower main channel 320 sending the water to a lower washing arm, and a sampling channel sending the water to the drain pump 110 are provided to the upper housing.

A channel expanding part 360 is formed on the sampling channel 310, and the pollution degree sensor 600 is installed at the channel expanding part 360. The first perforated hole 340 is provided to a center of the channel expanding part 360 to be penetrated by the pollution degree sensor 600. Preferably, the upper and lower housings 300 and 200 are separable. Alternatively, the upper and lower housings 300 and 200 can be built in one body.

The impeller 70 is situated between the upper and lower housings 300 and 200, and is shaft-coupled with the main motor 20. The impeller 70 makes a rotational movement by the main motor 20. And, the water is introduced into the introducing channel 220 by the rotational movement from the water receiving portion 120 of the sump 100. Namely, a washing pump includes the impeller 70 that pumps the water.

The water having passed through the introducing channel 220 is diverged to flow in the upper main channel 330, the lower main channel 320, and the sampling channel 310, respectively.

The channel control device includes the channel control valve 510, the valve control device 530 controlling the channel control valve 510, and a packing member (not shown in the drawing) situated between the channel control valve 510 and the valve control device 530.

The channel control valve 510 and the packing member are situated inside the sump 100, and the valve control device 530 is situated a lower end of an outside of the sump 100.

A filtering part 410 for filtering is provided to a central portion of the cover 400, and a recovery hole 440 having a predetermined shape is provided to a rim of the cover 400. The recovery hole 440 is provided to recover the water filtered by the filtering part 410 into the sump 100.

To the cover provided are an upper spray arm coupling portion 430 playing a role as a passage via which the water flows from the upper main channel to an upper spray arm and a lower spray arm coupling portion 420 playing a role as a passage via which the water flows from the lower main channel to a lower spray arm.

And, the cover 400 is built in one body of the upper housing 300 by thermal fusion. Alternatively, the cover 400 and the upper housing 300 are separately formed to be assembled together by a locking means.

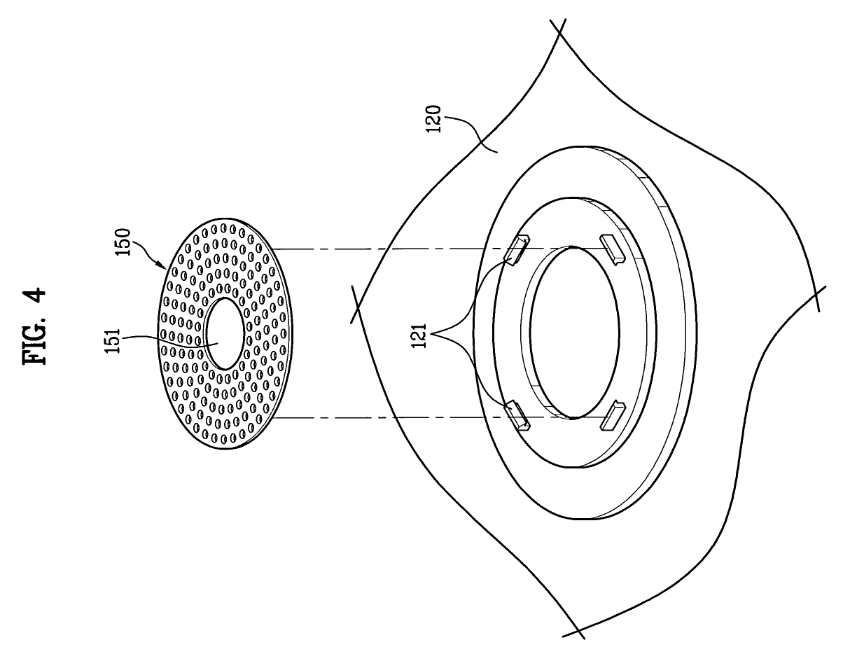

An installation configuration of the screen and disposer within the sump is explained with reference to FIGS. 3 to 6 as follows.

First of all, at least one hook 121 having a prescribed shape is provided to a bottom surface of the water receiving portion 120 formed at the sump 100, and the screen 150 is held by the hook 121 to filter of the soil involved in the water. Preferably, the hooks 121 are symmetrically formed.

The screen 150 is situated between the sump 100 and the lower housing 200 provided on the sump 100 to be operative in filtering of the soil involved in the water introduced into the lower housing 200. A passing hole 151 is formed at a center of the screen 150 to be penetrated by a shaft of the main motor, and a multitude of perforated holes 153 are formed at the screen 150 around the perforated hole 151.

The screen 150 is formed of metal such as stainless or alloy steel. Alternatively, the screen 150 can be formed of a plastic based material having a predetermined rigidity.

The disposer 140 is provided within the sump 100 to finely grind the soil involved in the water introduced into the lower housing 200. Specifically, the disposer 140 is situated below the screen 150 and is shaft-coupled with the main motor to rotate. Alternatively, the disposer 140 can be situated on the screen 150.

The disposer 140 has a lozenge shape and also has a rotational radius according to the shape of the disposer 140. Alternatively, the disposer 140 can have any kind of polygonal shape. Alternatively, the disposer can have a shape of a wing or saw blade.

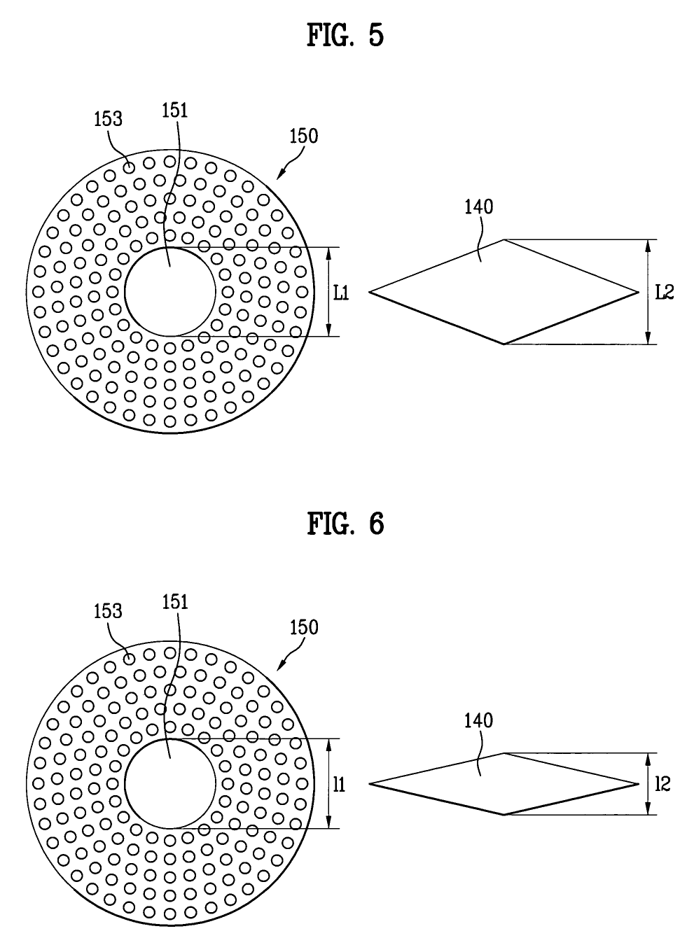

In the present invention, a width of the disposer 140 means a doubled distance between a rotational center and a rim of the disposer 140. A width L2 of the disposer, as shown in FIG. 5, is formed greater than a diameter L1 of the passing hole 151 of the screen 150.

This is to allow most of the water, which is being introduced into the lower housing 200, to pass through the perforated holes 153 of the disposer.

Alternatively, the width 12 of the disposer 140, as shown in FIG. 6, can be smaller than the diameter 11 of the passing hole 151 of the screen 150.

Meanwhile, an operation of the disposer and screen is explained as follows.

First of all, once a washing cycle is initiated, the main motor 20 provided beneath the sump and the impeller 70 shaft-coupled with the main motor 20 are rotated to pump the water to the lower and upper housings 200 and 300.

In doing so, the disposer 140 shaft-coupled with the main motor 20 is rotated to finely grind the soil involved in the water. And, the soil is filtered off by the screen 150 situated on the disposer 140.

Hence, it is less probably that the filter 410 is blocked by the soil having a relatively big size in the water entering the lower housing 200. So, the pressure of the water exerting on the filter 410 can be lowered.

Accordingly, the present invention provides the following advantages or effects.

First of all, by providing the screen having a multitude of the perforated holes and the disposer finely grinding the soil involved in the water, the present invention prevents the over-sized soil from entering the lower housing.

Secondly, by preventing the over-sized soil from entering the lower housing, the present invention lowers the pressure applied to the filter and prevents the transformation or distortion of the filter.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising:
a sump receiving water for washing dishes;
a main motor circulating the water received in the sump;
an impeller coupled with the main motor to pump the water; and
a screen provided between the sump and a lower housing provided over the sump to filter off soil included in the water introduced into the lower housing.

2. The dishwasher of claim 1, wherein the screen comprises a passing hole to be penetrated by a shaft of the main motor and a multitude of perforated holes through which the water passes.

3. The dishwasher of claim 2, wherein the passing hole is formed at a center of the screen.

4. The dishwasher of claim 1, wherein a hook is provided inside the sump to lock the screen.

5. The dishwasher of claim 1, further comprising a disposer finely grinding the soil included in the water introduced into the lower housing.

6. The dishwasher of claim 5, wherein the disposer is shaft-coupled with the main motor to be rotated.

7. The dishwasher of claim 6, wherein the disposer has a polygonal shape.

8. The dishwasher of claim 7, wherein a width of the disposer is greater than a diameter of the passing hole of the screen.
